(19) United States
(12) Patent Application Publication
(10) Pub. No.: US 2015/0201295 A1
(43) Pub. Date: Jul. 16, 2015

(54) Speaker with Lighting Arrangement

(71) Applicants: Chiu Yu Lau, Los Angeles, CA (US); Qun Ying MA, Los Angeles, CA (US)

(72) Inventors: Chiu Yu Lau, Los Angeles, CA (US); Qun Ying MA, Los Angeles, CA (US)

(21) Appl. No.: 14/155,302

(22) Filed: Jan. 14, 2014

(51) Int. Cl. H04R 29/00; H04R 1/02

(52) U.S. Cl. CPC H04R 29/008; H04R 1/028; H04R 1/026

(57) ABSTRACT

A speaker includes an audio arrangement and a lighting effect system. The audio arrangement includes a control module and a speaker module operatively linked to the control module, wherein the speaker module defines an audio output side in front of said speaker module for generating an audio signal. The lighting effect system includes a speaker cover coupled at the audio output side of the speaker module and a lighting arrangement supported by the speaker cover for generating a light effect at the audio output side of the speaker module to synchronize with the audio signal thereof, so as to provide a single light-and-audio source.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a speaker, and more particularly to a speaker with a lighting effect system for synchronizing the audio signal of the speaker module with the light effect, so as to provide a single light-and-audio source.

2. Description of Related Arts

People like to go clubbing because of the environment that makes people have fun and relaxing. Most prestigious clubs have elaborate lighting systems that throbbed to the beat of music. Accordingly, music and light effect are perfect combination in such a dark environment and are essential elements in the entertainment venue. In other words, speaker systems and different lighting systems are essential equipments in order to produce audio effect and light effects respectively in the entertainment venue.

Accordingly, the speaker systems and lighting systems are two individual systems. The speaker system generally comprises a floor-type speaker and a ceiling-type speaker. The floor-type speaker, such as a subwoofer, is stand on the floor surface that the floor-type speaker can be stably supported due to the vibration of audio output. The ceiling-type speaker usually has a lighter weight that it can be suspended and hung on the wall or under the ceiling. The lighting system refers to a laser light system, a spot light system, a neon light system, and/or disco light system, wherein the lighting system generally mounted under the ceiling away from the ceiling-type speaker.

Since the speaker systems and lighting systems are placed at different locations, the light source from the lighting system and the audio source from the speaker system will come from different directions to the user. The user as the receptor will sense the light source and the audio source in different directions, which may distract him or her from multiple directional sources.

Furthermore, the user is unable to see clearly in the dark environment and to alert the location of the speakers. When the user is distracted by the lighting systems, he or she has no safety awareness with the locations of the speakers and may be blocked the floor-type speakers.

### SUMMARY OF THE PRESENT INVENTION

A main object of the present invention is to provide a speaker, which comprises a lighting effect system for synchronizing the audio signal of the speaker module with the light effect, so as to provide a single light-and-audio source.

Another object of the present invention is to provide a speaker, wherein the lighting effect system comprises a speaker cover coupled at the audio output side of the speaker module to protect the speaker module.

Another object of the present invention is to provide a speaker, wherein the lighting arrangement is supported by the speaker cover to ensure the source of light effect to be the same as the source of audio signal.

Another object of the present invention is to provide a speaker, wherein the control module is electrically connected to the speaker module and the LED light, so that the control module will control both the audio signal and the light effect in a synchronizing manner.

Another object of the present invention is to provide a speaker, wherein the speaker comprises a portable floor casing with a foldable handle for enhancing the portability of the speaker, such that the user is able to easily carry the speaker from place to place.

Another object of the present invention is to provide a speaker, wherein the lighting effect system further comprises a disco light ball electrically connected to the control module to provide a disco light effect synchronized with the audio signal.

Another object of the present invention is to provide a speaker, wherein the speaker cover is detachably coupled at the audio output side of the speaker module, such that the speaker cover can be incorporated with different kinds of speaker module in order to synchronize the light effect with the audio signal of the speaker module.

Another object of the present invention is to provide a speaker, wherein the light arrangement comprises a sensor module which can detect the vibrating pressure of the speaker module and/or the loudness of the audio signal of the speaker module in order to control and synchronize the light effect with the audio signal.

Another object of the present invention is to provide a speaker, wherein the speaker cover can be manufactured by different kinds of shapes and sizes so as to implement with different kinds of speaker.

Another object of the present invention is to provide a speaker, wherein the speaker cover is easy to manufacture and simple in structure so as to reduce the manufacturing cost and manufacturing procedures.

Additional advantages and features of the invention will become apparent from the description which follows, and may be realized by means of the instrumentalities and combinations particular point out in the appended claims.

Accordingly, in order to achieve the above mentioned objects, the present invention provides a speaker comprising an audio arrangement and a lighting effect system.

The audio arrangement comprises a control module and a speaker module operatively linked to the control module, wherein the speaker module defines an audio output side in front of said speaker module for generating an audio signal.

The lighting effect system comprises a speaker cover coupled at the audio output side of the speaker module and a lighting arrangement supported by the speaker cover for generating a light effect at the audio output side of the speaker module to synchronize with the audio signal thereof, so as to provide a single light-and-audio source.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a front view of a speaker according to a preferred embodiment of the present invention.

FIG. 2 is a block diagram of the speaker according to the above preferred embodiment of the present invention.

FIG. 3 is an exploded perspective view of the lighting effect system of the speaker according to the above preferred embodiment of the present invention.

FIG. 4 is a sectional view of the lighting effect system of the speaker according to the above preferred embodiment of the present invention, illustrating a speaker cover coupled on an audio output side of the speaker module.

FIG. 5 illustrates an alternative mode of the lighting effect system of the speaker according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

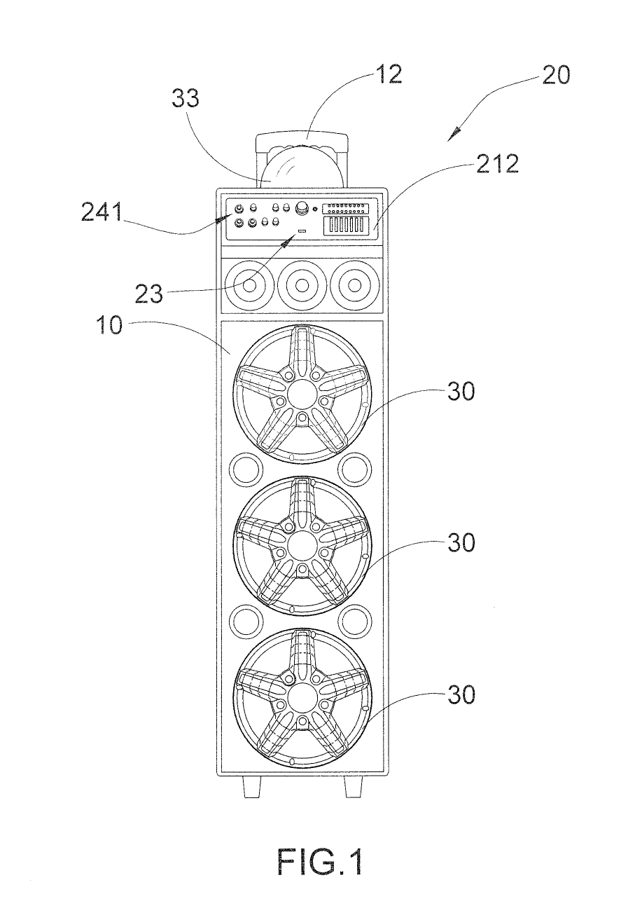

Referring to FIG. 1 of the drawings, a speaker with lighting effect according to a preferred embodiment of the present invention is illustrated, wherein the speaker comprises a portable floor casing 10, an audio arrangement 20 and a lighting effect system 30.

According to the preferred embodiment, the speaker is a portable all-in-one speaker adapted for being transported from place to place, wherein the user is able to input music from an external music player to the speaker of the present invention.

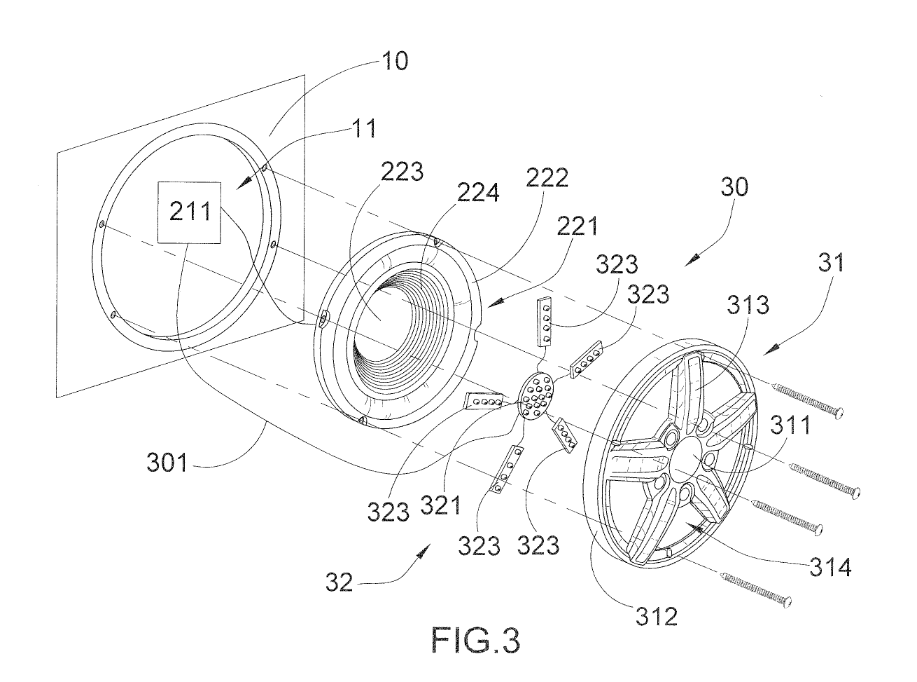

As shown in FIGS. 1 and 3, the audio arrangement 20 comprises a control module 21 and a speaker module 22 operatively linked to the control module 21, wherein the speaker module 22 defines an audio output side 221 in front of the speaker module 22 for generating an audio signal. Accordingly, the audio signal is generated by the speaker module 22 at the audio output side 221 as an output source of the audio signal.

As shown in FIG. 3, the portable floor casing 10 has at least a front opening 11, wherein the speaker module 22 is mounted at a front side of the floor casing 10 at the front opening 11. The portable floor casing 10 further comprises a foldable handle 12 for easily transporting the speaker, wherein foldable handle 12 is coupled at the rear side of the portable floor casing 10 and arranged in such a manner that when the foldable handle 12 is moved in a folded position, a handling portion of the foldable handle 40 is downwardly moved below the top side of the portable floor casing 10 and when the foldable handle 12 is moved in an unfolded position, the handling portion of the foldable handle 12 is upwardly moved above the top side of the portable floor casing 10. A plurality of transportation wheels are provided at the bottom side of the portable floor casing 10.

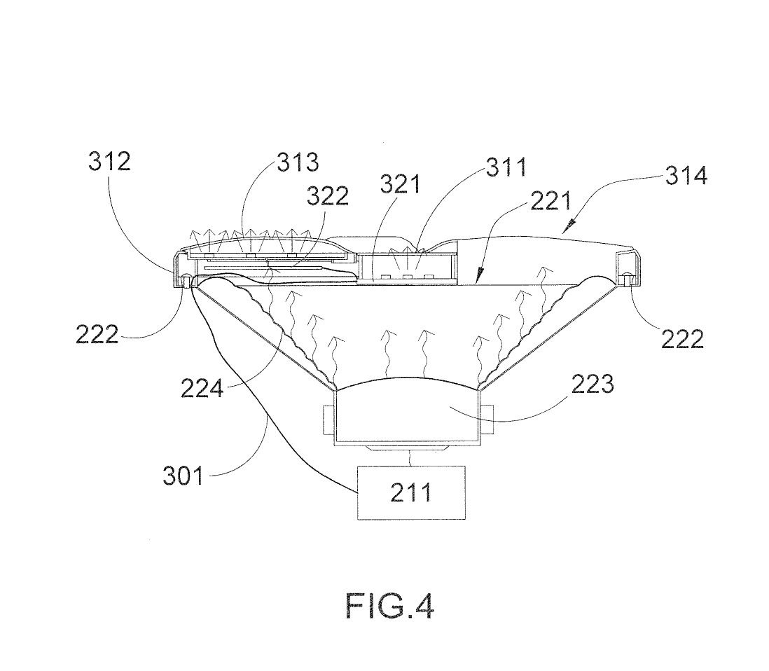

The lighting effect system 30 comprises a speaker cover 31 coupled at the audio output side 221 of the speaker module 22 and a lighting arrangement 32 supported by the speaker cover 31 for generating a light effect at the audio output side 221 of the speaker module 22 to synchronize with the audio signal thereof. Accordingly, the lighting arrangement 32 is provided at a rear side of the speaker cover 31 to generate the light effect at the front side of the speaker cover as an output source of the light signal. Therefore, the output source of the audio signal is located at the same of the output source of the light signal to provide a single light-and-audio source, as shown in FIG. 4.

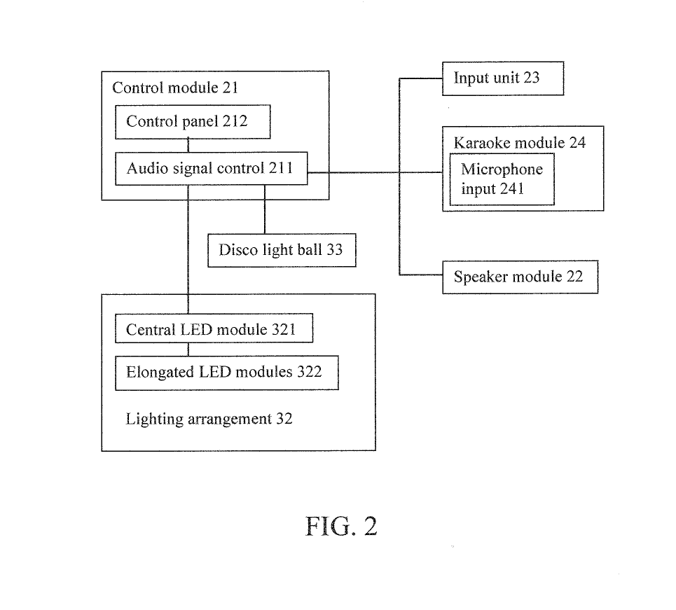

As shown in FIG. 2, the control module 21 comprises an audio signal control 211 received in the portable floor casing 10 and a control panel 212 provided at the front side of the portable floor casing 10 at a position above the speaker module 22 to operatively link to the audio signal control 211. Accordingly, the audio signal control 211 is arranged to receive an audio input and to output the audio signal to the speaker module 22, wherein the audio signal control 211 comprises a bass module, a volume module, a treble module, an input adjustment module, a guitar volume module, a microphone volume module, and a microphone echo module. The control panel 212 is operatively linked to the audio signal control 211 to control parameters of the audio signal output at the speaker module 22.

The speaker module 22 comprises a speaker frame 222, a voice coil 223, and a diaphragm 224 to reproduce the voice coil signal from the voice coil 223 by means of the vibration of the diaphragm 224, wherein a surrounding rim of the speaker frame 222 of the speaker module 22 is coupled at the front side of the portable floor casing 10 at the front opening 11 thereof.

According to the preferred embodiment, the audio arrangement 20 further comprises an input unit 23 operatively linked to the control module 21 for inputting an external audio signal to the control module, wherein the input unit 23 is at least one of a guitar input unit, a USB input, and a card reader. Preferably, the input unit 23 is provided at the control panel 212 of the control module 21 to operatively link to the audio signal control 211. Therefore, the external audio signal can be input to the audio signal control 211 and can be transmitted as the audio signal to be output at the speaker module 22.

The audio arrangement 20 further comprises a karaoke module 24 operatively linked to the control module 21, wherein the karaoke module 24 comprises a microphone input 241 for connecting a microphone to receive a vocal of the user to mix the vocal of the user with an audible sound to form the audio signal. Accordingly, the microphone input 241 is operatively linked to the audio signal control 211, wherein the vocal of the user can be selectively adjusted by the control panel 212. It is worth mentioning that the audible sound can be input through the input unit 23 or pre-stored in a database of the audio arrangement 20. In other words, when the microphone is plugged to the microphone input 241, the user is able to activate the karaoke module 24 for karaoke singing.

The speaker cover 31 is made of light weight but durable material. In particular, the speaker cover 31 is made of light transmitting material or translucent material that adapts the light from the light arrangement 32 passing from the rear side of the speaker cover 31 to the front side thereof.

According to the preferred embodiment, the speaker cover 31 comprises a central hub 311 coaxially aligned with a center of the speaker module 22, an outer rim 312 coaxially aligned with the central hub 311, and a plurality of supporting aims 313 radially and outwardly extended from the central hub 311 to the outer rim 312, wherein an audio output cavity 314 is defined between every two of the supporting arms 313 for enabling the audio signal passing through the audio output cavities 314. In other words, the speaker cover 31 will protect the diaphragm 224 of the speaker module 22, which is the weakest component of the speaker module 22, without blocking the audio signal therefrom.

The outer rim 312 of the speaker cover 31 is detachably coupled at the surrounding rim of the speaker frame 222 of the speaker module 22, wherein a diameter of the outer rim 312 matches with a diameter of the surrounding rim of the speaker frame 222 of the speaker module 22. Therefore, when the speaker cover 31 is coupled at the audio output side 221 of the speaker module 22, the speaker frame 222 will be hidden behind the rear side of the speaker cover 31 to enhance the aesthetic appearance of the speaker.

As shown in FIG. 4, the lighting arrangement 32 comprises a central LED module 321 mounted at the rear side of the central hub 311 and a plurality of elongated LED modules 322 which are operatively linked to the central LED module 321 and are mounted at the rear sides of the supporting arms 313 respectively for generating the light effect at the audio output side 221 of the speaker module 22. Accordingly, the central LED module 321 comprises a plurality of connecting ports positioned radially to connect with the elongated LED modules 322. The light effect generated by the central LED module 321 and the elongated LED modules 322 is dynamic lighting effect synchronizing with the audio signal.

According to the preferred embodiment, the control module 21 of the audio arrangement 20 is operatively linked to the lighting arrangement 32 for controlling and synchronizing the light effect by the lighting arrangement 32 in response to the audio signal. In particular, a control wire 301 is extended from the control module 21 within the portable casing 10 through the front opening 11 thereof to the central LED module 321 along the rear side of one of the supporting arms 313 of the speaker cover 32, so as to hide the control wire 301 behind the speaker cover 31. It is worth mentioning that the control wire 301 not only transmits a control signal from the control module 21 to the light arrangement 32 but also provides electrical power from the audio arrangement 20 to the light arrangement 32, such that no external power, such as battery, is required for adding to the light arrangement 32.

As shown in FIG. 1, the lighting effect system 30 further comprises a disco light ball 33 which is coupled at the top side of the portable floor casing 10 and is operatively linked to the control module 21 for generating a disco light effect synchronized with the audio signal.

Accordingly, when the control module 21 sends the audio signal to the speaker module 22, the control signal is also sent from the control module 21 to the lighting arrangement 32 and the disco light ball 33. In response to the audio signal output by the speaker module 22, the light effects by the lighting arrangement 32 and the disco light ball 33 will synchronize with the audio signal at the audio output side 221 of the speaker module 22.

As it is mentioned above, the output source of the audio signal is located at the same of the output source of the light signal to provide the single light-and-audio source, the user is able to listen to the audio signal and see the light effect at the same directional output source. At the same time, the light effect at the audio output side 221 of the speaker module 22 will also function as an indicating light to provide a safety awareness of the location of the speaker, especially the location of the speaker module 22.

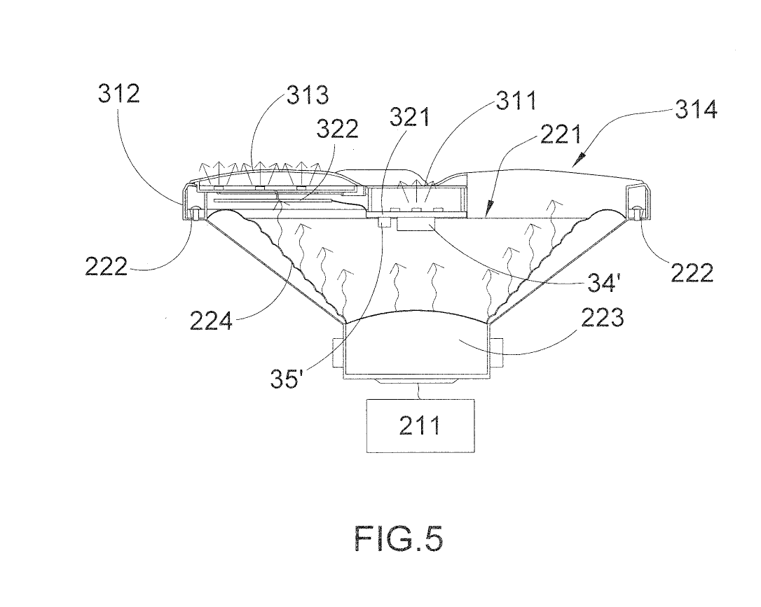

FIG. 5 illustrates an alternative mode of the lighting effect system 30′, wherein the speaker cover 31 can be detachably coupled at any speaker module 22 in order to synchronize the light effect with the audio signal. Accordingly, the lighting effect system 30′ further comprises a power source 34′ electrically linked to the lighting arrangement 32 and a sensor module 35′ coupled at the rear side of the speaker cover 31 for detecting the audio signal at the audio output side 221 of the speaker module 22 in order to synchronize the light effect with the audio signal.

Accordingly, the power source 34′ and the sensor module 35′ are supported at the rear side of the central hub 311 of the speaker cover 31. The power source 34′ can be a replaceable battery or a rechargeable battery. In other words, the light arrangement 32 can be self-operated without drawing any electrical power from the audio arrangement 20.

The sensor module 35′ can be a sound sensor coupled at the rear side of the speaker cover 31 for detecting a loudness of the audio signal of the speaker module 22 at the audio output side 221 in order to control and synchronize the light effect with the audio signal in response to the loudness of the audio signal. Alternatively, the sensor module 35′ can be a pressure sensor coupled at the rear side of the speaker cover 31 for detecting a vibrating pressure of the speaker module 22 via the diaphragm 224 thereof at the audio output side 221 in order to control and synchronize the light effect with the audio signal in response to the vibrating pressure.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A speaker, comprising:
an audio arrangement which comprises a control module and a speaker module operatively linked to said control module, wherein said speaker module defines an audio output side in front of said speaker module for generating an audio signal; and
a lighting effect system which comprises:
a speaker cover coupled at said audio output side of said speaker module; and
a lighting arrangement supported by said speaker cover for generating a light effect at said audio output side of said speaker module to synchronize with said audio signal thereof, so as to provide a single light-and-audio source.

2. The speaker, as recited in claim 1, wherein said speaker cover comprises a central hub coaxially aligned with a center of said speaker module and a plurality of supporting arms radially and outwardly extended from said central hub to define an audio output cavity between every two of said supporting arms for enabling said audio signal passing through said audio output cavities.

3. The speaker, as recited in claim 2, wherein said lighting arrangement comprises a central LED module mounted at a rear side of said central hub and a plurality of elongated LED modules which are operatively linked to said central LED module and are mounted at rear sides of said supporting arms respectively for generating said light effect at said audio output side of said speaker module.

4. The speaker, as recited in claim 2, wherein said speaker cover further comprises an outer rim coaxially aligned with said central hub that said supporting arms are radially extended from said central hub to said outer rim, wherein said outer rim is detachably coupled at a surrounding rim of said speaker module, wherein a diameter of said outer rim matches with a diameter of said surrounding rim of said speaker module.

5. The speaker, as recited in claim 3, wherein said speaker cover further comprises an outer rim coaxially aligned with said central hub that said supporting arms are radially extended from said central hub to said outer rim, wherein said outer rim is detachably coupled at a surrounding rim of said speaker module, wherein a diameter of said outer rim matches with a diameter of said surrounding rim of said speaker module.

6. The speaker, as recited in claim 1, further comprising a portable floor casing having at least a front opening, wherein said speaker module is mounted at a front side of said floor casing at said front opening.

7. The speaker, as recited in claim 5, further comprising a portable floor casing having at least a front opening, wherein said surrounding rim of said speaker module is mounted at a front side of said floor casing at said front opening.

8. The speaker, as recited in claim 6, wherein said lighting effect system further comprises a disco light ball which is coupled at a top side of said portable floor casing and is operatively linked to said control module for generating a disco light effect synchronized with said audio signal.

9. The speaker, as recited in claim 7, wherein said lighting effect system further comprises a disco light ball which is coupled at a top side of said portable floor casing and is operatively linked to said control module for generating a disco light effect synchronized with said audio signal.

10. The speaker, as recited in claim 3, wherein said control module is operatively linked to said lighting arrangement for controlling and synchronizing said light effect by said lighting arrangement in response to said audio signal.

11. The speaker, as recited in claim 9, wherein said control module is operatively linked to said lighting arrangement for controlling and synchronizing said light effect by said lighting arrangement in response to said audio signal.

12. The speaker, as recited in claim 10, wherein said control module is connected to said lighting arrangement by a control wire that extends from said control module to said central LED module along said rear side of one of said supporting arms of said speaker cover, so as to hide said control wire behind said speaker cover.

13. The speaker, as recited in claim 11, wherein said control module is connected to said lighting arrangement by a control wire that extends from said control module to said central LED module along said rear side of one of said supporting arms of said speaker cover, so as to hide said control wire behind said speaker cover.

14. The speaker, as recited in claim 1, wherein said audio arrangement further comprises a karaoke module operatively linked to said control module, wherein said karaoke module comprises a microphone input for connecting a microphone to receive a vocal of a user to mix the vocal of the user with an audible sound to form said audio signal.

15. The speaker, as recited in claim 5, wherein said audio arrangement further comprises a karaoke module operatively linked to said speaker module, wherein said karaoke module comprises a microphone input for connecting a microphone to receive a vocal of a user to mix the vocal of the user with an audible sound to form said audio signal.

16. The speaker, as recited in claim 11, wherein said audio arrangement further comprises a karaoke module operatively linked to said speaker module, wherein said karaoke module comprises a microphone input for connecting a microphone to receive a vocal of a user to mix the vocal of the user with an audible sound to form said audio signal.

17. The speaker, as recited in claim 1, wherein said audio arrangement further comprises an input unit operatively linked to said control module for inputting an external audio signal to said control module, wherein said input unit is selected from a group consisting of a guitar input unit, a USB input, and a card reader.

18. The speaker, as recited in claim 16, wherein said audio arrangement further comprises an input unit operatively linked to said control module for inputting an external audio signal to said control module, wherein said input unit is selected from a group consisting of a guitar input unit, a USB input, and a card reader.

19. The speaker, as recited in claim 1, wherein said lighting effect system further comprises a power source electrically linked to said lighting arrangement and a pressure sensor coupled at a rear side of said speaker cover for detecting a vibrating pressure of said speaker module at said audio output side in order to control and synchronize said light effect with said audio signal in response to said vibrating pressure.

20. The speaker, as recited in claim 1, wherein said lighting effect system further comprises a power source electrically linked to said lighting arrangement and a sound sensor coupled at a rear side of said speaker cover for detecting a loudness of said audio signal of said speaker module at said audio output side in order to control and synchronize said light effect with said audio signal in response to the loudness of said audio signal.
